(19) United States
(12) Patent Application Publication
(10) Pub. No.: US 2010/0110616 A1
(43) Pub. Date: May 6, 2010

(54) Disconnect switch with overcurrent device and enclosure for reduced hazard

(76) Inventor: Thomas G. Edel, Portland, OR (US)

Correspondence Address: THOMAS G. EDEL, 3519 SE 71ST AVE, PORTLAND, OR, 97206-2527, US

(21) Appl. No.: 12/655,622

(22) Filed: Jan. 4, 2010

(51) Int. Cl. H02B 1/18; H02B 1/32

(52) U.S. Cl. 361/642; 361/643

(57) ABSTRACT

A disconnect switch and an overcurrent protection device are combined in a single enclosure which has two isolated compartments, with independent access to each compartment. The enclosure is adapted for mounting on a vertical surface (suitable for mounting on a wall). The disconnect switch is contained within a first compartment, and the overcurrent protection device is contained within a second compartment. Interconnecting conductors connect the disconnect switch to the overcurrent protection device through an enclosure wall which separates the two compartments. After installation in an electric power system, when the disconnect switch is in the OFF position, shock hazards and arc-flash hazards are present only within the compartment containing the disconnect switch. The compartment containing the overcurrent protection device is completely de-energized, and can therefore be safely accessed for maintenance, inspection, and testing.

### CROSS-REFERENCE TO RELATED APPLICATION

Not Applicable

### STATEMENT REGARDING FEDERALLY SPONSORED RESEARCH

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to the art of controlling electricity in electric power systems. More specifically, it relates to the art of providing disconnecting means and overcurrent protection for conductors and loads. The invention is most applicable to low-voltage alternating-current electrical systems, but may be applicable to almost any type of electric power system, both alternating-current systems and direct current systems. As used herein, the term “low voltage” refers to voltages less than about 1000V. In the United States, “low voltage” is often taken to mean 600V and lower (though its meaning varies depending on the context).

FIG. 1 illustrates a prior-art fused disconnect switch, rated for use on a low-voltage electrical system. The fused disconnect switch shown provides both a means of disconnecting power to a load, as well as overcurrent protection for the load and load conductors. A 3-pole switch 1 has an external operating handle 2. Switch 1 is shown generically as a “black box,” whereas many embodiments have switch blades which are visible and exposed, providing a disconnect means with an open state which is easy to verify visually. While FIG. 1 shows a 3-pole switch and three fuses, the number of switch poles and fuses may vary, depending on the application. A single-pole or double-pole switch (and just one or two fuses) may be used for a single-phase system. Any number of poles (a plurality of poles), and a corresponding number of fuses, may be used for a multi-phase system. Three-pole devices (as shown) for use in three-phase electrical systems are perhaps the most common.

The switch and fuses are contained within an enclosure 6, which has a hinged door 7. The hinged door is normally provided with one or more latching mechanisms 20 to keep it closed during normal use. It is common for a safety interlock mechanism (not shown) to be included, which prevents the door from being opened while the switch is closed. Enclosure 7 is usually intended for mounting on a vertical surface, either by screws through the back of the enclosure, or external mounting ears may be provided (not shown).

Switch 1 has three termination lugs (termination lug 4 is typical) which provide a termination means for connecting supply conductors of an electric power system. Mechanical (screw-type) lugs are shown, but it should be noted that other types of termination means may be used.

Three fuses (fuse 3 is typical) provide overcurrent protection for a load, which may be connected with load conductors connecting to three more termination lugs (termination lug 5 is typical).

When applied in situations covered by NFPA 70 (National Electrical Code), switch 1 may function as a “disconnecting means” and the one or more fuses may be considered to be an “overcurrent protection device.”

By opening switch 1, electric power is removed both from the load, and from the fuses within the fused disconnect switch. However, hazardous voltages are still present within enclosure 6 (at the upstream side of switch 1), and service personnel are exposed to these hazardous voltages whenever it is necessary to inspect or replace the fuses. Barriers may be included to reduce the hazard, but the hazard is still present.

Similarly, FIG. 2 illustrates a prior-art molded-case circuit breaker installed within enclosure, which often serves a similar purpose as the fused disconnect switch shown in FIG. 1. A circuit breaker 8 may function as both a disconnecting means and as an overcurrent protection device. In FIG. 2, an operating mechanism 2A is installed over circuit breaker 8 to enable operation by external operating handle 2. By opening the circuit breaker, electric power is removed both from a connected load, and from the load side of the circuit breaker. However, hazardous voltages are still present within the enclosure (at the upstream side of the circuit breaker), and service personnel are exposed to these hazardous voltages whenever it is necessary to inspect the circuit breaker, or to adjust the trip settings of the circuit breaker (if it is an adjustable type of circuit breaker). Barriers may be included to reduce the hazard, but the hazard is still present.

In recent years, the hazards associated with arcing faults have become more widely known, and safety codes have been developed to help protect electrical workers from the hazards associated with so-called arc-flash hazards. Presently, requirements associated with arc-flash safety, such as NFPA-70E-2009, article 130, focus on labeling equipment with the hazard level, and requiring workers to utilize appropriate protective clothing and equipment if the equipment must be opened while energized. The hazard level is dependent on calculated arcing fault current magnitude and the maximum time required for an upstream overcurrent protection device to clear the fault. Slow fault clearing times combined with high fault currents produce the greatest hazard levels. However, very high arc-flash hazards can also result from relatively low fault current levels combined with relatively long clearing times.

A problem arises when the arc-flash hazard level is high, and there is not a practical way to turn electric power to the equipment OFF for servicing. A common example is service equipment installed at many facilities. Often a fused disconnect switch (similar to FIG. 1) or a circuit breaker (similar to FIG. 2) is used as a service disconnect (a main switch used to disconnect utility power from the entire facility). Facility personnel generally don't have access to the utility system to turn power OFF upstream of the service disconnect. Upstream disconnecting means and overcurrent protection devices are often utility-owned fuse cutouts on the primary side of a utility-owned transformer. The fuses often have slow characteristics resulting in high arc-flash hazard at the service disconnect switch. The hazard may be too high to safely open the enclosure of the service disconnect, even with protective equipment in place. If the service disconnect has fuses which need replacing, or the equipment otherwise needs inspecting, adjusting, or testing, the only safe solution is to call the utility and wait for a utility line crew to disconnect power on the primary side on the utility transformer. This situation is often not acceptable.

One partial solution to this problem, using prior-art equipment, is to provide a disconnect switch and an overcurrent protection device in separate enclosures, thereby providing a way to isolate the overcurrent protection device from the hazard on the upstream side of the disconnect switch. However, this solution is not optimal. It requires additional wall space, and additional time to install two pieces of equipment.

It is therefore an object and advantage of the present invention to provide an improved disconnect switch configuration which provides improved safety for accessing overcurrent protection devices which are contained within the same enclosure as a disconnect switch.

### BRIEF SUMMARY OF THE INVENTION

A disconnect switch and an overcurrent protection device are combined in a single enclosure which has two isolated compartments, with independent access to each compartment. The enclosure is adapted for mounting on a vertical surface (suitable for mounting on a wall). The disconnect switch is contained within a first compartment, and the overcurrent protection device is contained within a second compartment. Interconnecting conductors connect the disconnect switch to the overcurrent protection device through an enclosure wall which separates the two compartments.

After installation in an electric power system, when the disconnect switch is in the OFF position, shock hazards and arc-flash hazards are present only within the compartment containing the disconnect switch. The compartment containing the overcurrent protection device is completely de-energized, and can therefore be safely accessed for maintenance, inspection, and testing.

Stated another way, the invention is a combination of a switch, an overcurrent protection device, interconnecting conductors, and an enclosure. The switch, the overcurrent device, and the interconnecting conductors are contained within the enclosure. The enclosure is adapted for mounting on a vertical surface. The switch is connected to the overcurrent protection device with the interconnecting conductors. The improvement is that the enclosure comprises a first compartment and a second compartment; the switch being contained within the first compartment; the overcurrent protection device being contained within said second compartment. The combination further functions to remove electric power from the second compartment when the switch is open, thereby providing improved safety for accessing and servicing the overcurrent protection device.

### BRIEF DESCRIPTION OF THE DRAWINGS

FIG. 1 illustrates a prior-art fused disconnect switch in an enclosure.

FIG. 2 illustrates a prior-art molded-case circuit breaker in an enclosure.

FIG. 3 illustrates a fused disconnect switch according to the present invention. The fuses are in a compartment which is separate from a compartment containing the switch.

FIG. 4 illustrates a circuit breaker and disconnect switch, in separate compartments.

FIG. 5 is similar to FIG. 3, except that the interconnecting conductors between compartments are now routed in a common bushing.

FIG. 6 is similar to FIG. 4, except that the interconnecting conductors between compartments are now routed in a common bushing.

### DETAILED DESCRIPTION OF THE INVENTION

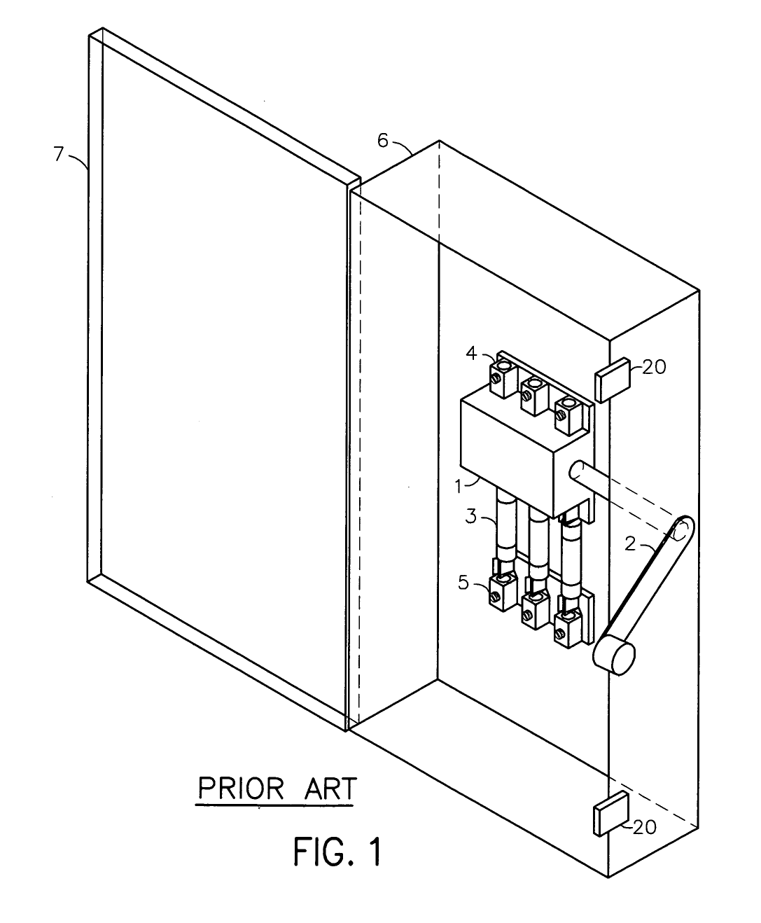

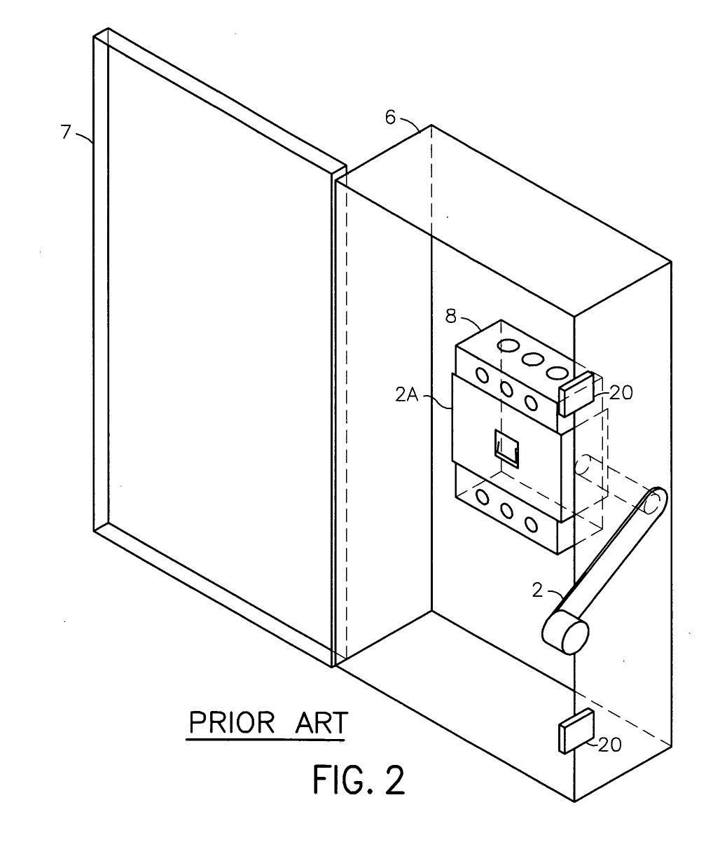

FIG. 1 and FIG. 2 have already been discussed, under “Background of the Invention.”

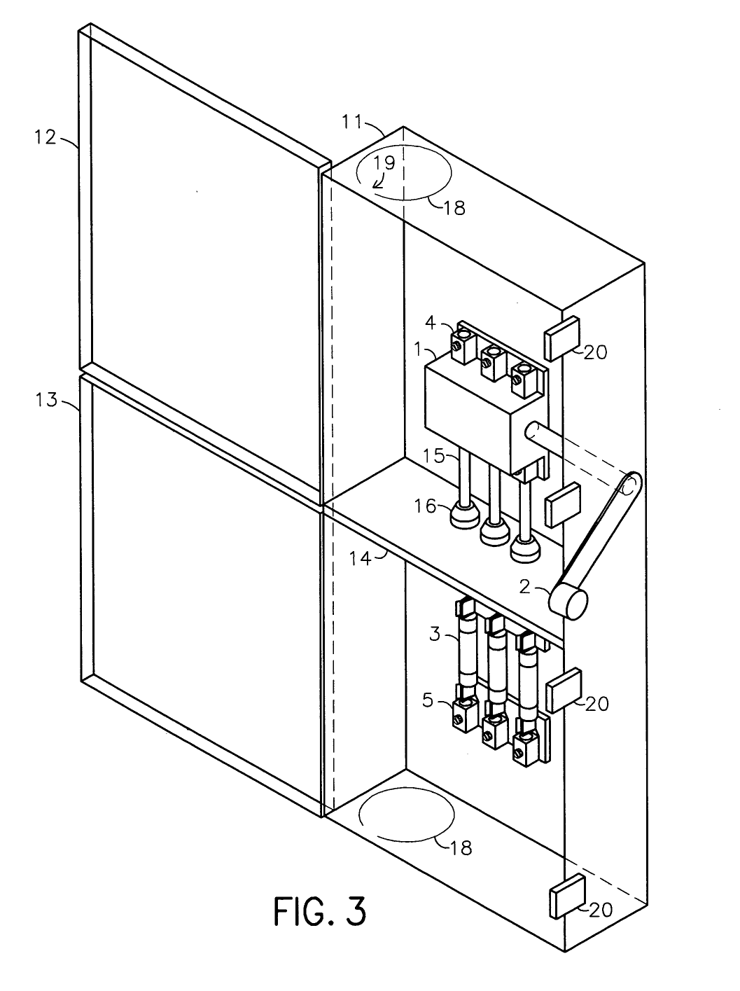

FIG. 3 illustrates a fused disconnect switch according to the present invention. FIG. 3 shows, in combination, a switch 1, an overcurrent protection device comprising three fuses (fuse 3 is typical), interconnecting conductors (interconnecting conductor 15 is typical of three shown), and an enclosure 11. Enclosure 11 has an upper compartment (or a “first compartment”) with a hinged door 12, and a lower compartment (or a “second compartment”) with a hinged door 13. An enclosure wall 14 separates the upper compartment from the lower compartment. Switch 1 is isolated in the upper compartment, and the three fuses (fuse 3 is typical) are isolated in the lower compartment. Latching mechanisms 20 are used to keep the doors closed during normal use. The type of latching mechanisms used may vary widely, in accordance with the wide variation of prior-art latching mechanisms available. A safety interlock mechanism (not shown) may also be included, which prevents the doors from being opened while switch 1 is closed.

Three interconnecting conductors (conductor 15 is typical) connect switch 1 to the fuses. Three cable glands or bushings (16) provide penetration means for the interconnecting conductors to pass through wall 14. The interconnecting conductors may be insulated wire, non-insulated wire, insulated bus bar, or non-insulated bus bar. The penetration means may use any prior-art materials such as one or more insulating bushings (providing a passageway for one or more conductors), one or more bushings with integral conductor, one or more cable glands, one or more grommets, or simply one or more holes in wall 14. If a neutral conductor is required, an additional penetration means through wall 14 may be included.

Wall 14 provides a safety barrier between the upper compartment and the lower compartment. Since there must be interconnecting conductors between the two compartments, it is necessary to have a penetration means through wall 14. Several different penetration means were just listed in the paragraph above. To prevent hazardous gases associated with an arcing fault from going through the penetration(s), it is preferable to utilize a penetration means which minimizes this possibility, such as cable glands or bushings with integral conductors.

An arcing fault may generate sufficient explosive effect to blow open an enclosure door. To mitigate this hazard, the preferred embodiment includes one or more pressure-relief panels 18. In the embodiment shown, these are simply partly-punched-out circular panels in an outer wall of the enclosure, similar to standard conduit knockouts, but with connecting material only on one side of the pressure-relief panel. The unpunched connecting material 19 provides a hinge mechanism for the panel to open when internal pressure is high. The length of connecting material 19 should be such that the panel opens at an appropriate amount of pressure. The amount of pressure required to open the pressure-relief panel should be coordinated with the strength of the door hinges and door latching mechanisms, so that the pressure-relief panel opens at a pressure which is smaller than would cause failure of the door. Connecting material 19 is located so as to cause panel 18 to open in such a way that explosive gases are directed away from personnel who may be in front of the enclosure. More-elaborate pressure relief mechanisms may be preferred for some applications.

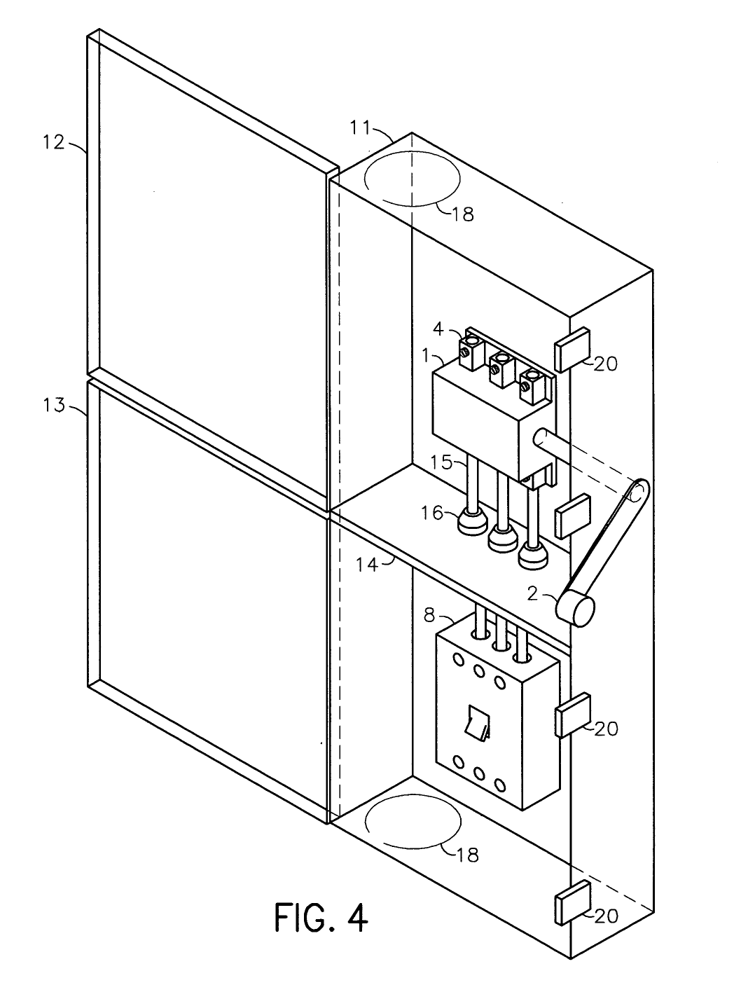

FIG. 4 illustrates a circuit breaker and disconnect switch, in separate compartments. FIG. 4 is similar to FIG. 3, except that circuit breaker 8 now replaces the fuses for overcurrent protection. FIG. 4 shows, in combination, switch 1, an overcurrent protection device (circuit breaker 8), interconnecting conductors (interconnecting conductor 15 is typical of three shown), and an enclosure 11.

Circuit breaker 8 does not require an external operating handle, since switch 1 provides a disconnecting means. Circuit breaker 8 primarily functions as an overcurrent protection device. In the configuration shown, switch 1 provides a way to remove power from the lower compartment, so that circuit breaker 8 can be safely accessed and serviced. Some applications may benefit from a second external operating handle to provide for external operation for circuit breaker 8.

Termination lugs, on both the line side and load side of the circuit breaker, are concealed within the circuit breaker enclosure, and are not visible in FIG. 4.

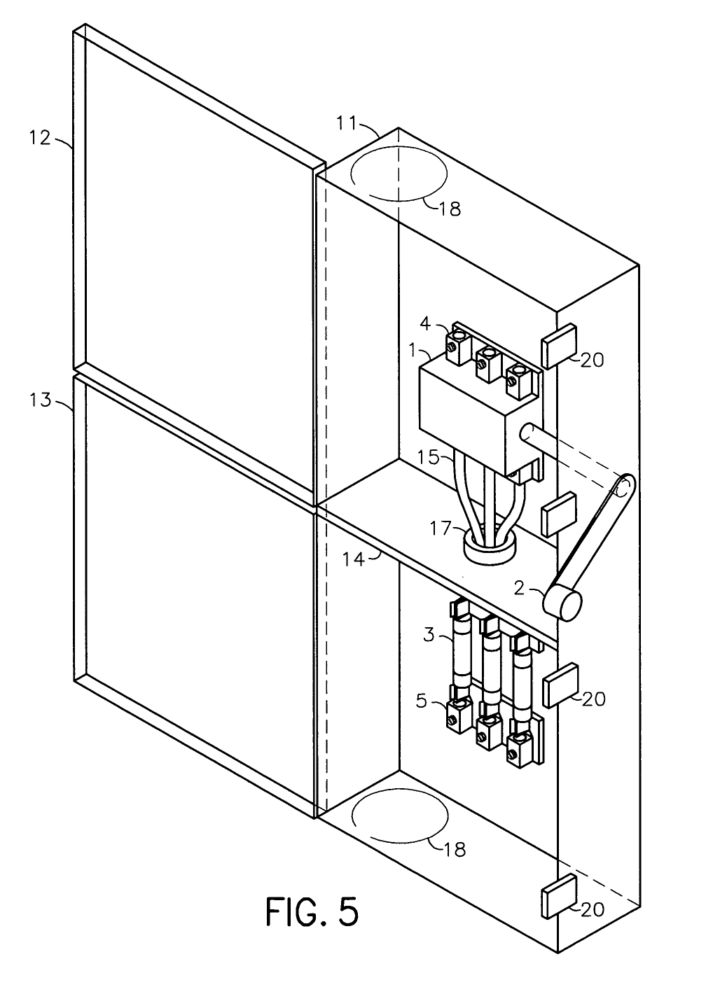

FIG. 5 is similar to FIG. 3, except that the interconnecting conductors between compartments (interconnecting conductor 15 is typical of three shown) are now routed in a common bushing. This configuration provides a convenient raceway for additional unswitched conductors, such as neutral conductors. This configuration may also be somewhat less expensive than the configuration shown in FIG. 3. However, the common bushing provides a passageway for expanding gases resulting from an arcing fault in the adjacent compartment, and may not be preferred for that reason.

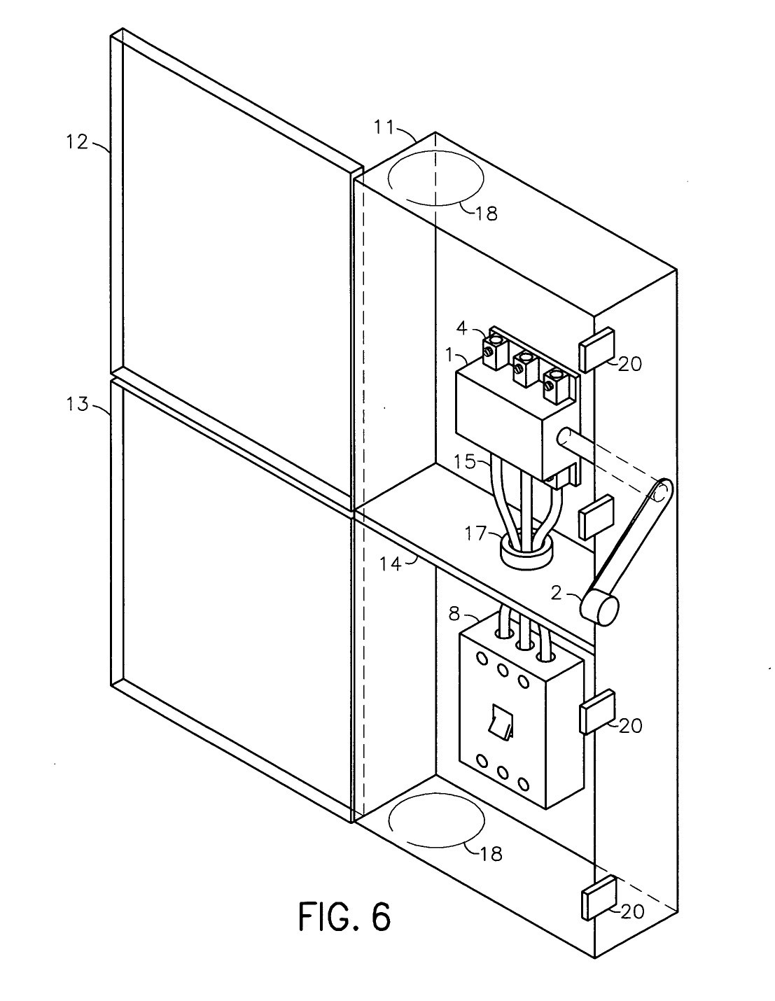

FIG. 6 is similar to FIG. 4, except that the interconnecting conductors between compartments (interconnecting conductor 15 is typical of three shown) are now routed in a common bushing. This configuration provides a convenient raceway for additional unswitched conductors, such as neutral conductors. This configuration may also be somewhat less expensive than the configuration shown in FIG. 4. However, the common bushing provides a passageway for expanding gases resulting from an arcing fault in the adjacent compartment, and may not be preferred for that reason.

While several embodiments have been described and illustrated, there are many other embodiments possible that will be apparent to those skilled in the art. It is not the intent of this disclosure to limit the invention to the embodiments that have been illustrated. The components and configurations utilized in this disclosure are intended to be illustrative only, and are not intended to limit the scope of the appended claims.

While only certain preferred features of the invention have been shown by way of illustration, many modifications and changes will occur to those skilled in the art. It is, therefore, to be understood that the appended claims are intended to cover all such modifications and changes as fall within the true spirit of the invention.

I claim:

1. In combination: a switch, an overcurrent protection device, interconnecting conductors, and an enclosure; said switch, said overcurrent protection device, and said interconnecting conductors being contained within said enclosure; said enclosure being adapted for mounting on a vertical surface; said switch being connected to said overcurrent protection device with said interconnecting conductors; said combination intended for connection to an electric power system;
wherein the improvement is that said enclosure comprises a first compartment and a second compartment; said switch being contained within said first compartment; said overcurrent protection device being contained within said second compartment; said combination functioning to remove electric power from said second compartment when said switch is open, thereby providing improved safety for accessing and servicing said overcurrent protection device.

2. The combination of claim 1 wherein said combination functions as a disconnecting means for disconnecting a load from said electric power system, and also functions to provide overcurrent protection for load conductors supplying said load.

3. The combination of claim 1 wherein said combination is rated for use on a low-voltage electrical system.

4. The combination of claim 1 wherein said switch comprises a first termination means for connecting said switch to supply conductors of said electric power system, and said overcurrent protection device comprises a second termination means for connecting said overcurrent protection device to load conductors.

5. The combination of claim 1 wherein said overcurrent protection device is selected from the group consisting a circuit breaker and one or more fuses.

6. The combination of claim 1 wherein said combination is suitable for use with a single-phase electrical system.

7. The combination of claim 1 wherein said switch has a plurality of poles, and said combination is suitable for use with a multi-phase electrical system.

8. The combination of claim 1 wherein said interconnecting conductors are selected from the group consisting of insulated wire, non-insulated wire, insulated bus bar, and non-insulated bus bar.

9. The combination of claim 8 further comprising penetration means for said interconnecting conductors to pass through a wall of said enclosure which separates said first compartment from said second compartment; said penetration means being selected from the group consisting of one or more insulating bushings, one or more bushings with integral conductor, one or more cable glands, one or more grommets, and one or more holes in said wall.

10. The combination of claim 1 wherein said enclosure further comprises one or more pressure-relief mechanisms, said pressure relief mechanism operating to limit pressure within said enclosure in case of an arcing fault within said enclosure.

11. The combination of claim 1 wherein said switch further comprises an operating handle operable from the outside of said enclosure while one or more doors of said enclosure are closed.

12. The combination of claim 1 wherein said enclosure further comprises a first hinged door providing access to said first compartment, and a second hinged door providing access to said second compartment.

13. The combination of claim 12 wherein said enclosure further comprises latching mechanisms to keep said first hinged door and said second hinged door closed, and a safety interlock mechanism for preventing said first hinged door and said second hinged door from being opened while said switch is closed.

14. The combination of claim 1 wherein said combination functions such that an arc-flash hazard associated with said second compartment is eliminated by opening said switch.

15. The combination of claim 2 wherein said combination is rated for use on a low-voltage electrical system; said switch comprises a first termination means for connecting said switch to supply conductors of said electric power system; said overcurrent protection device comprises a second termination means for connecting said overcurrent protection device to said load conductors; and wherein said overcurrent protection device is selected from the group consisting a circuit breaker and one or more fuses.

16. The combination of claim 15 wherein said switch has a plurality of poles, and said combination is suitable for use with a multi-phase electrical system; said interconnecting conductors are selected from the group consisting of insulated wire, non-insulated wire, insulated bus bar, and non-insulated bus bar; and further comprising penetration means for said interconnecting conductors to pass through a wall of said enclosure which separates said first compartment from said second compartment; said penetration means being selected from the group consisting of one or more insulating bushings, one or more bushings with integral conductor, one or more cable glands, one or more grommets, and one or more holes in said wall.

17. The combination of claim 16 wherein said switch further comprises an operating handle operable from the outside of said enclosure while one or more doors of said enclosure are closed; said enclosure further comprises a first hinged door providing access to said first compartment, and a second hinged door providing access to said second compartment; and wherein said enclosure further comprises latching mechanisms to keep said first hinged door and said second hinged door closed, and a safety interlock mechanism for preventing said first hinged door and said second hinged door from being opened while said switch is closed.

18. The combination of claim 17 wherein said combination functions such that an arc-flash hazard associated with said second compartment is eliminated by opening said switch.

19. The combination of claim 18 wherein said enclosure further comprises one or more pressure-relief mechanisms, said pressure relief mechanism operating to limit pressure within said enclosure in case of an arcing fault within said enclosure.
